(19) United States
(12) Patent Application Publication
(10) Pub. No.: US 2026/0228257 A1
(43) Pub. Date: Aug. 6, 2026

(54) INFORMATION PROCESSING SYSTEM, INFORMATION PROCESSING APPARATUS, AND INFORMATION PROCESSING METHOD

(71) Applicant: Genki Watanabe, Tokyo (JP)

(72) Inventor: Genki Watanabe, Tokyo (JP)

(73) Assignee: Ricoh Company, Ltd., Tokyo (JP)

(21) Appl. No.: 19/442,349

(22) Filed: Jan. 7, 2026

(30) Foreign Application Priority Data
Jan. 31, 2025 (JP) 2025-014570

(51) Int. Cl. G06F 16/3329; G06F 16/338

(52) U.S. Cl. CPC G06F 16/33295; G06F 16/338

(57) ABSTRACT

An information processing system includes circuitry that receives a message input from a user, transmits an instruction to artificial intelligence (AI) based on a first processing flow associated with a first interactive AI or a second processing flow associated with a second interactive AI, and displays response content obtained from the AI based on the first processing flow or the second processing flow.

### CROSS-REFERENCE TO RELATED APPLICATIONS

This patent application is based on and claims priority pursuant to 35 U.S.C. § 119(a) to Japanese Patent Application No. 2025-014570, filed on Jan. 31, 2025, in the Japan Patent Office, the entire disclosure of which is hereby incorporated by reference herein.

### BACKGROUND

### Technical Field

The present disclosure relates to an information processing system, an information processing apparatus, and an information processing method.

### Related Art

There is devised a computer system that automatically generates a response to a message such as a question from a user and outputs the response to interact with the user.

For example, a prompt to be input to an artificial intelligence (AI) is generated using a template prepared in advance.

Preparation of a large language model (LLM) dedicated to handling of a specific document by fine tuning is also being studied.

### SUMMARY

The present disclosure described herein provides an information processing system including: circuitry that activates at least one of a first interactive artificial intelligence (AI) and a second interactive AI that each interact with a user using response content generated by an AI; a memory that stores a first processing flow and the first interactive AI in association, and a second processing flow and the second interactive AI in association; and a display to display the response content. The circuitry receives a message input from the user. Based on a determination that the first interactive AI is to process the message, the circuitry transmits an instruction based on the first processing flow to the AI, the first processing flow causing the first interactive AI to generate response content to be responded to the message of the user, and displays the response content obtained from the AI based on the first processing flow on a display. Based on a determination that the second interactive AI is to process the message, the circuitry transmits an instruction based on the second processing flow to the AI, the second processing flow causing the second interactive AI to generate response content to be responded to the message of the user, and displays the response content obtained from the AI based on the second processing flow on the display.

The present disclosure described herein provides an information processing apparatus including: circuitry that activates at least one of a first interactive artificial intelligence (AI) and a second interactive AI that each interact with a user using response content generated by an AI; and a memory that stores a first processing flow and the first interactive AI in association, and a second processing flow and the second interactive AI in association. The circuitry receives a message input from the user. Based on a determination that the first interactive AI is to process the message, the circuitry transmits an instruction based on the first processing flow to the AI, the first processing flow causing the first interactive AI to generate response content to be responded to the message of the user, and displays the response content obtained from the AI based on the first processing flow on a display. Based on a determination that the second interactive AI is to process the message, the circuitry transmits an instruction based on the second processing flow to the AI, the second processing flow causing the second interactive AI to generate response content to be responded to the message of the user, and displays the response content obtained from the AI based on the second processing flow on the display.

The present disclosure described herein provides an information processing method including: receiving a message input from a user; and determining an interactive artificial intelligence (AI) configured to process the message from among a first interactive AI and a second interactive AI that each interact with the user using response content generated by an AI. When the determining determines that the first interactive AI is to process the message, the method further includes: transmitting an instruction based on a first processing flow to the AI, the first processing flow being stored in a memory in association with the first interactive AI and causing the first interactive AI to generate response content to be responded to the message of the user; and displaying the response content obtained from the AI based on the first processing flow on a display. When the determining determines that the second interactive AI is to process the message, the method further includes: transmitting an instruction based on a second processing flow to the AI, the second processing flow being stored in the memory in association with the second interactive AI and causing the second interactive AI to generate response content to be responded to the message of the user, and displaying the response content obtained from the AI based on the second processing flow on the display.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a configuration of an information processing system according to a first embodiment;

FIG. 2 is a diagram illustrating an example of a hardware configuration of an information processing apparatus according to the first embodiment;

FIG. 3 is a diagram illustrating an example of a functional configuration of the information processing system according to the first embodiment;

FIG. 4 is a table of an example of an agent information storage unit;

FIG. 5 is a table of an example of a history information storage unit;

FIG. 6 is a sequence diagram illustrating an example of an operation performed by the information processing system according to the first embodiment;

FIG. 7 is a view illustrating an example of display of an interactive screen at the start of conversation;

FIG. 8 is a view illustrating an example of display of final response information;

FIG. 9 is a view illustrating an example of display of an interactive screen presenting switching of an execution agent;

FIG. 10 is a sequence diagram illustrating an example of an operation performed by an information processing system according to a second embodiment; and

FIG. 11 is a view illustrating an example of display of an interactive screen that causes a user to select whether to switch an execution agent.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

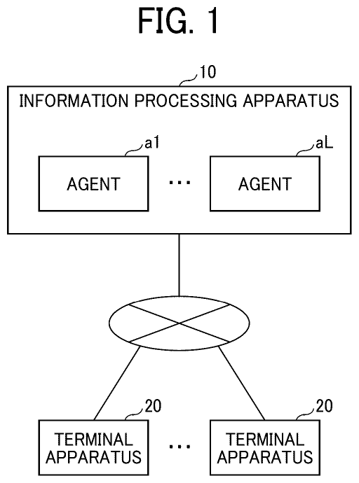

Embodiments of the present disclosure will be described hereinafter with reference to the drawings. FIG. 1 is a diagram illustrating an example of a configuration of an information processing system according to a first embodiment. In FIG. 1, one or more terminal apparatuses 20 are connected to an information processing apparatus 10 via a network such as a local area network (LAN) or the Internet.

The information processing apparatus 10 is one or more computers that provide multiple types of agents a1 to aL that interact with a user using response content generated by an AI. The agent is an example of an interactive AI, and is an anthropomorphic virtual entity that appears to the user as a conversation partner. The conversation with the interactive AI (conversation partner) refers to that, when the user inputs a message, a response to the message is output. Specifically, the agent receives a message input by the user from the terminal apparatus 20, controls generation of a response to the message, and outputs the response to the terminal apparatus 20. The message input by the user may be a question, an instruction, a request, or any other input information to be responded. The response is text including information corresponding to the message. The text may be output by voice as the response to the message. The agent may also be referred to, for example, as automatic response means, an AI agent, a digital clone, a personalized AI, an AI assistant, an automatic response AI, a conversation partner, an AI chatbot, a companion, a concierge, and a virtual interactive interface. The agent may be a virtual human displayed on the screen of the terminal apparatus 20 as a conversation partner, for example, in the form of a three-dimensional (3D) avatar imitating a person. In the present embodiment, examples of the multiple types of agents include a first interactive AI and a second interactive AI.

The information processing apparatus 10 provides multiple types of agents. The multiple types of agents are distinguished from each other by, for example, how to control generation of a response to a message. The multiple types of agents have different roles on an agent basis and are distinguished from each other, for example, based on the purpose or application. Examples of the role of the agent include inquiry (question and response), comparison, classification, prediction, document generation, document supplementation, and document evaluation. An agent may be defined for each of these roles, or an agent corresponding to another role may be defined.

The user can select, as the conversation partner, an agent suitable for the purpose or application of the user from among the multiple types of agents. When the information processing apparatus 10 determines to change the agent suitable for the message from the user in accordance with the progress of the conversation, the information processing apparatus 10 can automatically switch the agent as the conversation partner.

The terminal apparatus 20 functions as a user interface of the information processing system. For example, a personal computer (PC), a smartphone, or a tablet terminal may be used as the terminal apparatus 20. The terminal apparatus 20 receives an input of a message from the user and transmits the message to the information processing apparatus 10. The terminal apparatus 20 also receives a response generated in response to the message from the information processing apparatus 10 and displays the response. The terminal apparatus 20 may output received information using a projector.

In the present embodiment, the information processing system operates in a certain company (hereinafter referred to as a “company X”). Thus, the user who can access the information processing apparatus 10 is a person belonging to the company X, such as an employee of the company X. The service provided by the information processing apparatus 10 may be open to the public as a cloud service.

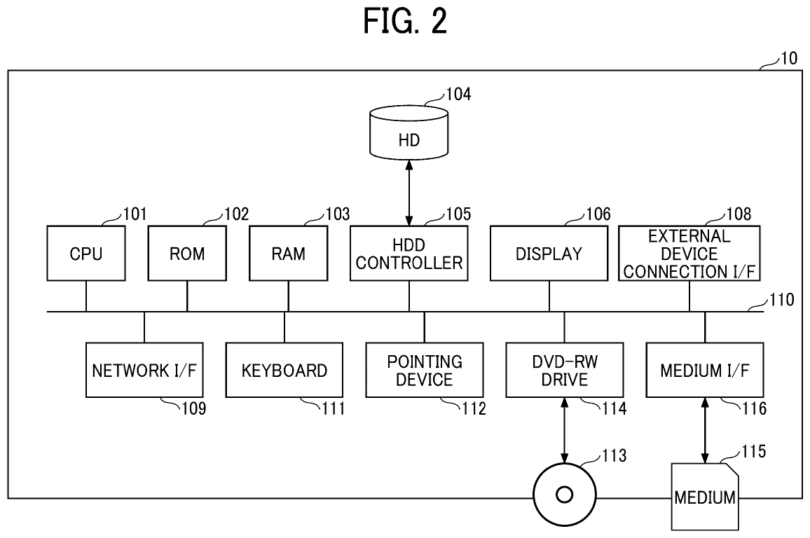

FIG. 2 is a diagram illustrating an example of a hardware configuration of the information processing apparatus 10 according to the first embodiment. As illustrated in FIG. 2, the information processing apparatus 10 is implemented by a computer. The information processing apparatus 10 includes a central processing unit (CPU) 101, a read-only memory (ROM) 102, a random-access memory (RAM) 103, a hard disk (HD) 104, a hard disk drive (HDD) controller 105, a display 106, an external device connection interface (I/F) 108, a network I/F 109, a bus line 110, a keyboard 111, a pointing device 112, a digital versatile disk rewritable (DVD-RW) drive 114, and a media I/F 116.

The CPU 101 controls the overall operation of the information processing apparatus 10. The ROM 102 stores, for example, a program such as an initial program loader (IPL) used for booting the CPU 101. The RAM 103 is used as a work area for the CPU 101. The HD 104 stores various data such as a program. The HDD controller 105 controls the reading of various data from, or the writing of various data to, the HD 104 under the control of the CPU 101. The display 106 displays various types of information, such as a cursor, a menu, a window, text, or an image. The external device connection I/F 108, which may be implemented by an interface circuit, is an interface for connection with various external devices. Examples of the external devices include, but not limited to, a Universal Serial Bus (USB) memory and a printer. The network I/F 109 is an interface circuit that controls communication of data with various external devices through a communication network. The bus line 110 is, for example, an address bus or a data bus that electrically connects the components such as the CPU 101.

The keyboard 111 is an example of an input device provided with multiple keys used for inputting characters, numerical values, and various instructions. The pointing device 112 is an example of an input device that allows selection or execution of various instructions, selection of a processing target, and movement of a cursor. The DVD-RW drive 114 controls the reading of various data from, or the writing of various data to, a DVD-RW 113, which is an example of a removable recording medium. The removable recording medium is not limited to a DVD-RW and may be, for example, a digital versatile disc recordable (DVD-R). The media I/F 116 controls the reading of data from, or the writing (storing) of data to (in), a recording medium 115 such as a flash memory.

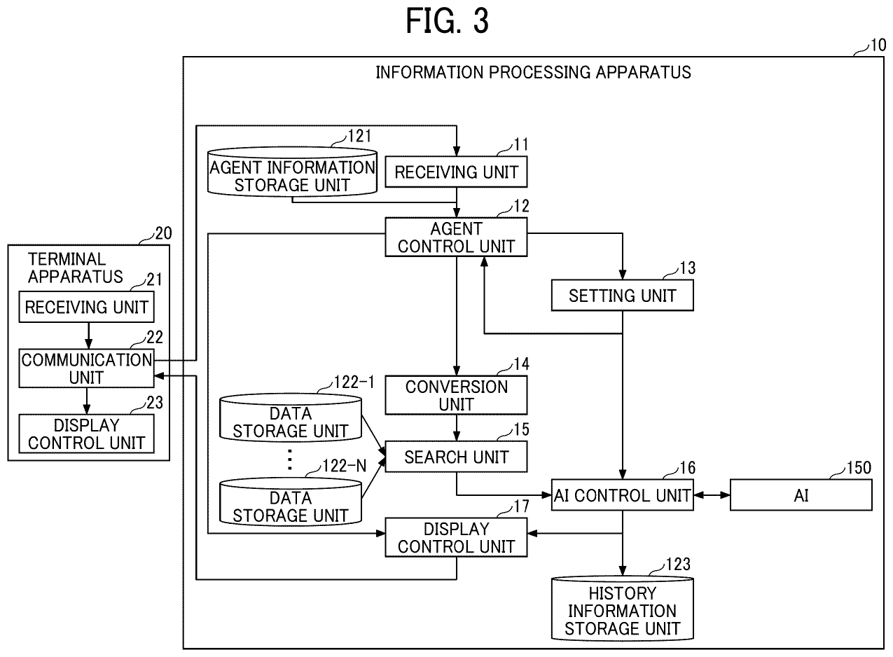

FIG. 3 is a diagram illustrating an example of a functional configuration of the information processing system according to the first embodiment. The information processing apparatus 10 illustrated in FIG. 3 includes an AI 150 and an agent.

The AI 150 is a machine learning model (e.g., neural network) that receives an input of text and that is trained to generate text (hereinafter referred to as a “response”) corresponding to the input text (hereinafter referred to as a “prompt”). The AI 150 may be trained to output a response including an image, a file, or any other data. The AI 150 generates, for example, text having the highest appearance probability as the response to the prompt, based on the learning result. For example, a generation AI using a large language model (LLM) may be used as the AI 150. The LLM is a machine learning model that has learned natural language processing using a large amount of text data. The LLM is used in many natural language processing (NLP) tasks such as generation of a response to a specific question, automatic generation of sentences, summarization of text, translation, and emotion analysis. The LLM can also be used for various applications such as education, entertainment, customer service, and product development. In the present embodiment, text including a message input by the user serves as the prompt. The AI 150 does not have to be operated on the information processing apparatus 10. For example, the AI 150 may be the generation AI that is open to the public, such as the one available on the Internet.

Machine learning is a technology for making a computer acquire human-like learning ability. Machine learning refers to a technology in which a computer autonomously generates an algorithm to be used for a determination such as data identification from training data obtained in advance and applies the generated algorithm to new data to make a prediction. Any suitable learning method is used in machine learning. For example, any one of supervised learning, unsupervised learning, semi-supervised learning, reinforcement learning, and deep learning, or a combination of two or more of those learning methods may be used.

The agent is a set of functional units that receives a message from the user, uses retrieval augmented generation (RAG) for the AI 150 to generate a response to the message, and performs a process of adding text generated by the AI 150 in the past (a response output from the AI 150 to a prompt input to the AI 150 in the past) to a prompt. Specifically, the agent includes, as such functional units, a receiving unit 11, an agent control unit 12, a setting unit 13, a conversion unit 14, a search unit 15, an AI control unit 16, and a display control unit 17. These units are implemented by processes that one or more programs installed in the information processing apparatus 10 cause the CPU 101 to perform. The agent also uses, as storage units, an agent information storage unit 121, multiple data storage units 122-1 to 122-N, and a history information storage unit 123. The storage units may be implemented by, for example, the HD 104 or a storage device that is connectable to the information processing apparatus 10 via a network.

While the information processing apparatus 10 functions as the multiple types of agents a1 to aL in the present embodiment, a program that functions as an agent (hereinafter referred to as an “agent program”) is common to the agents. The agent program causes the information processing apparatus 10 to function as the multiple types of agents based on information set in advance on an agent basis (hereinafter referred to as “agent information”).

The receiving unit 11 receives an input from the user. For example, the receiving unit 11 receives, from the user, selection of an agent to be the conversation partner (hereinafter referred to as an “execution agent”) from among the multiple types of agents a1 to aL. The receiving unit 11 also receives an input of a message to the agent, which is the conversation partner. To be exact, the input by the user is performed on the terminal apparatus 20. Thus, the receiving unit 11 receives, from the terminal apparatus 20, information corresponding to the input received by the terminal apparatus 20.

The agent control unit 12 controls switching of the execution agent. When the user selects an agent a1, the agent control unit 12 performs a process of determining the selected agent a1 as the execution agent. When the execution agent is automatically switched in accordance with the progress of the conversation, the agent control unit 12 functions as an example of a determination unit that determines whether an agent a2 (second interactive AI) is present among the multiple types of agents. The agent a2 can output, to the message received by the receiving unit 11, a response more appropriate than that of the agent a1 (first interactive AI) that is the current execution agent (conversation partner). The agent control unit 12 functions as an example of a switching unit that switches the conversation partner to the second agent when it is determined that the second agent is present. In a process of switching a certain agent to the execution agent, the agent control unit 12 inputs, to the setting unit 13, agent information of the execution agent among the agent information stored in the agent information storage unit 121 in association on an agent basis. When the execution agent is automatically switched in accordance with the progress of the conversation, the agent control unit 12 performs a process of automatically switching the execution agent, based on the agent information stored in the agent information storage unit 121 on an agent basis and the message from the user.

Agent information of a certain agent among the agent information stored on an agent basis includes text information indicating the role of the agent, identification information of the data storage unit 122 corresponding to the agent (hereinafter referred to as a “data source ID”), and a processing flow corresponding to the agent. The processing flow of the agent is data for controlling the behavior as the interactive AI and generating response content to be responded to the message. The processing flow includes a process of transmitting, to the AI 150, an instruction to generate response content to output response content (a final response described below) as the interactive AI to the message. In the present embodiment, the processing flow is implemented by a control rule and a system prompt.

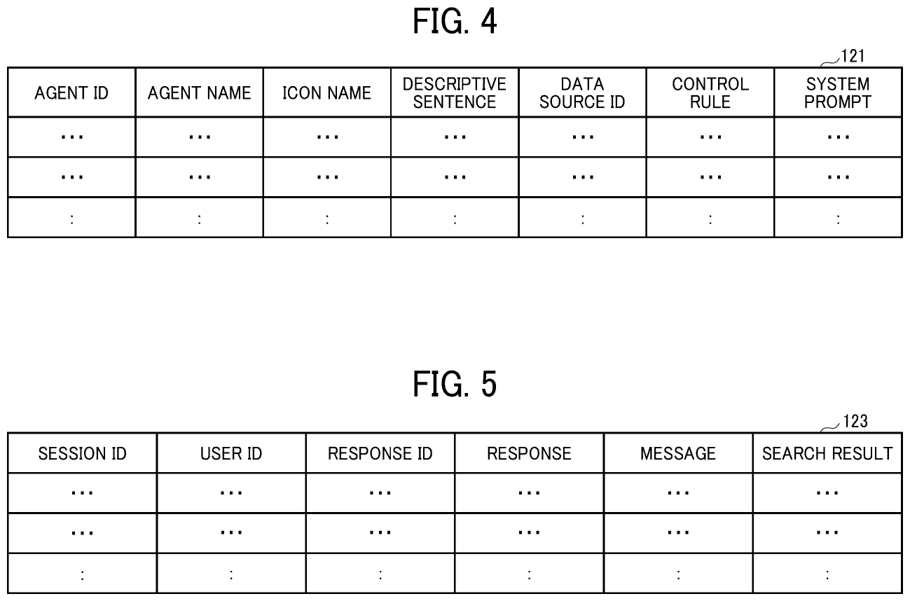

FIG. 4 is a table of an example of the agent information storage unit 121. As presented in FIG. 4, the agent information storage unit 121 stores in advance agent information including an agent ID, an agent name, an icon name, a descriptive sentence, a data source ID, a control rule, a system prompt, and the like for each agent to be a selection candidate.

The agent name is the name of an agent. The icon name is the file name of an icon representing the agent. The icon is displayed on a screen (interactive screen) for conversation between the user and the agent. The descriptive sentence is text data describing, for example, the role of the agent in natural language. The data source ID is identification information of the data storage unit 122 to be searched by the agent. Two or more data storage units 122 may be a search target. The control rule and the system prompt are a control rule and a system prompt for causing the AI control unit 16 to correspond to the agent. Since the control rule and the system prompt are defined for each agent, multiple different types of control rules and system prompts are prepared in advance. Even when multiple agents search the same data source, by using different control rules for the multiple agents, different responses are obtained from the agents. That is, the role of the agent is implemented by the control rule and the system prompt. For example, in the case of an inquiry agent having a role of outputting an inquiry answer for answering an inquiry (question) from the user, a descriptive sentence describing such a role, and a control rule and a system prompt for controlling the agent in such a manner are stored in association with the inquiry agent. In the case of an analysis agent having a role of analyzing data in response to an instruction from the user and outputting an analysis result, a descriptive sentence describing such a role, and a control rule and a system prompt for controlling the agent in such a manner are stored in association with the analysis agent.

The system prompt is a template (form) of a prompt that is prepared in advance for each agent (each role) and that indicates an instruction to be input to the AI 150. For example, the message received by the receiving unit 11 is applied to a system template to generate a prompt to be input to the AI 150.

The control rule is data that defines a procedure for input/output (interaction) of the AI 150 and is prepared in advance for each agent (each role). In order to obtain a response to a certain message input by the user according to the role of the execution agent, it is not sufficient to input a prompt to the AI 150 once, and it may be desirable to cause the AI 150 to perform, for example, multiple tasks such as extraction and classification of identification information, prediction, and loop processing. In this case, a prompt is to be input for each task. The control rule is data that defines information indicating which prompts are to be input to the AI 150 and in which order the prompts are to be input to the AI 150 (i.e., a procedure of interaction with the AI 150). The interaction with the AI 150 based on one control rule is hereinafter referred to as a “control procedure,” and one input of a prompt to the AI 150 in the control procedure is referred to as a “phase.” When the control procedure includes multiple phases, a system prompt corresponding to each phase is prepared. The processing flow of the agent corresponding to the control rule including the multiple phases includes multiple system templates (instructions) to be sequentially transmitted to the AI 150. The control rules of different agents may differ from each other in the number of multiple system templates (multiple instructions) to be sequentially transmitted to the AI 150. The multiple system templates (instructions) include, for example, a first system template (first instruction) and a second system template (second instruction) based on which a prompt to be transmitted to the AI 150 is generated when a response to (a prompt based on) the first system template is obtained from the AI 150. For example, the second system template instructs the AI to respond using a response from the AI 150 to the prompt based on the first system template. To the system prompt of a certain phase, a message received by the receiving unit 11 may be applied. To the system prompt of another phase, a response obtained before the phase in the control procedure may be applied. To distinguish a response obtained from the AI 150 in the middle of the control procedure from a response finally obtained from the AI 150 in the control procedure (i.e., a response to a message from the user), the former is referred to as an “intermediate response” and the latter is referred to as a “final response.” The final response is an example of the response content from the agent to the user. When a prompt is to be input once in the control procedure, the control rule includes one phase, and the number of system prompts is one.

In this case, there is no intermediate response, and the final response is obtained in response to one input of the prompt. In the present embodiment, a process of transmitting a prompt to the AI 150 and obtaining a response for each phase will be described, but this does not imply any limitation. In the phase, the information processing apparatus 10 may perform a predetermined process on data to obtain data corresponding to the intermediate response or the final response without interaction with the AI 150, or may perform input/output interaction of data with another information processing apparatus via a network or an application programming interface (API) to obtain the intermediate response or the final response.

The setting unit 13 sets the AI control unit 16 and the search unit 15 to cause the AI control unit 16 and the search unit 15 to perform behaviors corresponding to the role of the execution agent, based on the agent information of the execution agent input from the agent control unit 12. The switching of the execution agent is implemented by switching the settings on the AI control unit 16 and the search unit 15. The setting of the AI control unit 16 is switched for each agent because the system prompt and the control rule differ on an agent basis. That is, the processing flow (the system prompt and the control rule) included in the agent information of the execution agent is set on the AI control unit 16. In contrast, the setting on the search unit 15 is switched for each agent because the data storage unit 122 to be searched (from which document data is acquired) may differ on an agent basis. For example, an agent a3 related to legal knowledge searches the data storage unit 122 storing document data related to law, and an agent a4 related to accounting knowledge searches the data storage unit 122 storing document data related to accounting. The search unit 15 is set with the data source ID included in the agent information of the execution agent.

When the receiving unit 11 receives a message, the conversion unit 14 converts the message into a vector (hereinafter referred to as a “semantic vector”) representing the meaning of the message with a multi-dimensional numerical value. The semantic vector can be generated using natural language processing such as bidirectional encoder representations from transformers (BERT). Hereinafter, the semantic vector generated by converting the message is referred to as a “message vector.”

The search unit 15 uses the message vector generated by the conversion unit 14 to extract document data having relatively high relevance to the message from among items of document data stored in the data storage unit 122 corresponding to the data source ID set by the setting unit 13. That is, the data storage unit 122 to be searched by the search unit 15 (from which document data is acquired) changes depending on the setting made by the setting unit 13.

Document data related to various types of work of the company X is stored (registered) in advance in each data storage unit 122. The set of stored document data differs on a data storage unit 122 basis. This is because agents having different roles use different sets of document data. Thus, the data storage unit 122 may be prepared for each agent. Some or all of the data storage units 122 used by two or more agents may be the same. The document data may be registered in each data storage unit 122 in a batch manner, or the user may upload the document data at any timing. Each data storage unit 122 stores, for each document data registered in the data storage unit 122, the document data and a semantic vector for each chunk of the document data. The chunk of document data refers to a portion of the document data obtained by dividing the document data in predetermined units.

The dividing unit of the document data may be defined by the number of characters, the number of sentences, or a semantic unit (for example, a paragraph). The chunks of the document data may be stored in advance, after the document data is divided in units. Hereinafter, the semantic vector of each chunk is referred to as a “chunk vector.” The search unit 15 compares, for each document data of the data storage unit 122 to be searched, the message vector with the chunk vector of each chunk related to the document data and identifies a chunk (hereinafter referred to as a “similar chunk”) related to a chunk vector having the highest degree of similarity to the document data. The search unit 15 compares the degrees of similarity of similar chunks of respective items of document data and extracts the top M similar chunks having the highest degrees of similarity. Thus, M items of document data are substantially extracted. To evaluate the similarity between the vectors, a cosine similarity may be used, or another index may be used. The search unit 15 adds information (hereinafter referred to as “related document information”) including the top M similar chunks, IDs (hereinafter referred to as “chunk IDs”) stored in the data storage unit 122 in association with the similar chunks, IDs (hereinafter referred to as “document IDs”) stored in the data storage unit 122 in association with document data to which the similar chunks belong, and file names (hereinafter referred to as “document names”) to the search result. Each data storage unit 122 may be managed based on a folder, a database, or any other management unit of the set of document data.

The AI control unit 16 applies the message received by the receiving unit 11 and the set of similar chunks related to the search result obtained by the search unit 15 to the system prompt set by the setting unit 13 to generate a prompt. That is, the AI control unit 16 generates a prompt obtained by expanding the message received by the receiving unit 11 using the set of similar chunks related to the search result obtained by the search unit 15. A method of adding the set of similar chunks related to the search result to the prompt may be similar to that of known RAG. Text of each chunk belonging to the set of similar chunks related to the search result may be added to the prompt, or a vector generated based on the chunk vector of the chunk may be added to the prompt. An example of the system prompt is as follows.

<Example of system prompt begins.>

Message from user is as follows.

{Message}

Generate response to message with reference to following documents.

{Set of similar chunks related to search result}

<Example of system prompt ends.>

As described above, the system prompt clearly defines a portion to which the message is applied and a portion to which the set of similar chunks related to the search result obtained by the search unit 15 is applied. In this case, the AI control unit 16 applies the message received by the receiving unit 11 to the {message} portion of the system prompt and applies the set of similar chunks related to the search result obtained by the search unit 15 to the {set of similar chunks related to search result} portion of the system prompt to generate a prompt. By inputting the prompt generated in this manner to the AI 150, the AI 150 can generate a response by using even the information included in the set of similar chunks related to the search result, which includes information that the AI 150 has not learned. That is, the response from the AI 150 may be based on the set of similar chunks related to the search result. The system prompt may include a character string for notifying the AI 150 of the role of the agent corresponding to the system prompt, such as “You are XXX.” (where XXX is a character string indicating the role).

When the control procedure includes multiple phases, a system prompt specifying, for a certain phase, a portion to which an intermediate response obtained in a phase before the certain phase (e.g., an intermediate response obtained in any phase from the first phase to the (K-1)-th phase with respect to the K-th phase) is applied may be defined.

The AI control unit 16 also performs interaction with the AI 150 based on the system template set by the setting unit 13 in the control procedure according to the control rule set by the setting unit 13. For each phase of the control procedure, the AI control unit 16 generates a prompt based on the system prompt corresponding to the phase, transmits the prompt to the AI 150, and receives a response to the prompt from the AI 150. Thus, when the receiving unit 11 receives a message to the execution agent, the AI control unit 16 controls the AI 150 to generate a response to the message based on the processing flow set by the setting unit 13. The processing flow set by the setting unit 13 differs depending on the execution agent. Thus, when a message to the first interactive AI (agent) is received, the AI control unit 16 transmits an instruction based on the first processing flow to the AI 150, and when a message to the second interactive AI (agent) is received, the AI control unit 16 transmits an instruction based on the second processing flow to the AI 150.

Further, each time a final response is obtained from the AI 150, the AI control unit 16 stores, in the history information storage unit 123, the final response in association with the message and the search result based on which the final response is obtained. The intermediate response may also be stored in association with the final response. Thus, the history information storage unit 123 stores history information of conversation between the user and the agent (input/output of the AI 150).

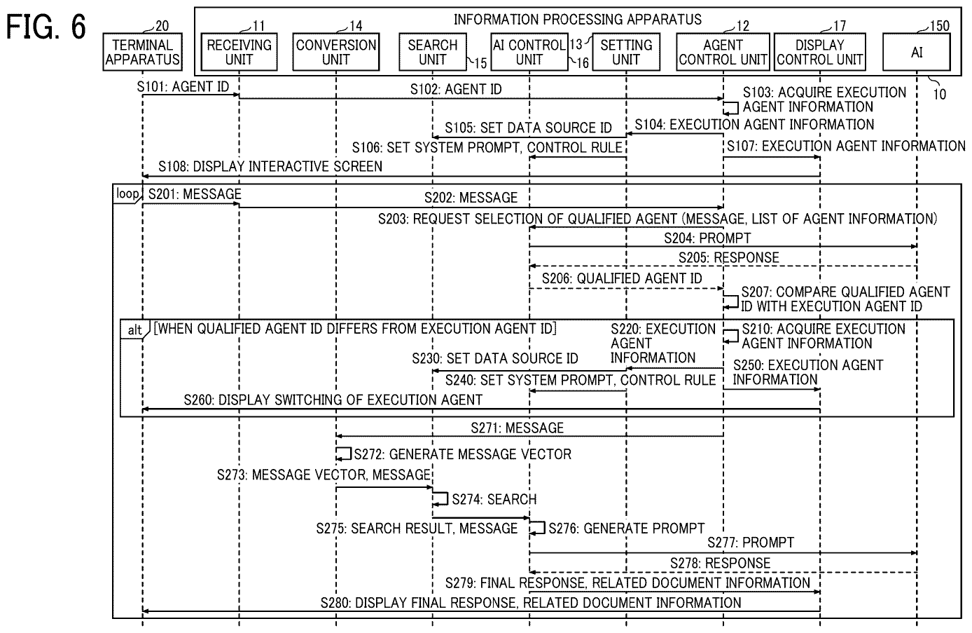

FIG. 5 is a table of an example of the history information storage unit 123. As illustrated in FIG. 5, the history information storage unit 123 stores history information including a session ID, a user ID, a response ID, a response, a message, and a search result for each final response from the AI 150. The session ID is an ID unique to each session. The session refers to a series of interaction of a message and a final response (or an intermediate response may be included) between the user and the agent, the interaction being performed during a period from when an interactive screen 510 is displayed to when the interactive screen 510 is closed. The same session ID is assigned to final responses output in the same session. The user ID is identification information of the user who has performed a session (conversation) related to the session ID. The user ID may be identified by user authentication. The response ID is, for example, an ID unique to each final response and is assigned by the AI control unit 16 when, for example, recording the final response in the history information storage unit 123. The response is, for example, each final response identified with the response ID. The message and the search result are a message and a search result applied to the prompt based on which the final response is obtained. The response may not be stored in the table of FIG. 5.

The display control unit 17 causes the agent, which is the conversation partner with the user, to be displayed in an identifiable manner. Further, the display control unit 17 causes information including the final response received by the AI control unit 16 (hereinafter referred to as “final response information”) to be displayed on the terminal apparatus 20 from which the message is transmitted. Specifically, the display control unit 17 transmits display content for displaying a screen of the terminal apparatus 20 to the terminal apparatus 20. The terminal apparatus 20 displays the screen based on the display content using a browser. The final response information includes the final response and information indicating the document data to which each similar chunk related to the search result obtained by the search unit 15 belongs. Thus, the user can check the document data based on which the final response is generated.

When the execution agent has been switched, the display control unit 17 causes the fact that the conversation partner has been switched to be displayed on the terminal apparatus 20 in an identifiable manner.

The terminal apparatus 20 includes a receiving unit 21, a communication unit 22, and a display control unit 23. These units are implemented by processes that a program installed in the terminal apparatus 20 causes the CPU of the terminal apparatus 20 to perform.

The receiving unit 21 receives an operation on the terminal apparatus 20 by the user.

The communication unit 22 controls communication with the information processing apparatus 10.

The display control unit 23 controls display of a screen (e.g., an interactive screen 510 described below), based on information (display data) received from the information processing apparatus 10.

An operation performed by the information processing system will be described hereinafter. FIG. 6 is a sequence diagram illustrating an example of the operation performed by the information processing system according to the first embodiment. At the start of the operation of FIG. 6, the user has logged in to the information processing apparatus 10 (has been authenticated by the information processing apparatus 10), and an execution agent selection screen is displayed on the terminal apparatus 20. The execution agent selection screen displays a list of selectable agents. The list at this time may include agents in an order sorted based on the roles of the agents (e.g., in alphabetical order of character strings indicating the roles).

Some of the agents in the list can perform search. In this case, a keyword for search may be input on the execution agent selection screen, and some agents having relatively high similarity in role to the keyword may be displayed on the execution agent selection screen.

When one of the agents displayed on the execution agent selection screen is selected by the user, in step S101, the terminal apparatus 20 transmits identification information of the selected agent (hereinafter referred to as an “agent ID”) to the information processing apparatus 10.

When receiving the agent ID, in step S102, the receiving unit 11 of the information processing apparatus 10 inputs the agent ID to the agent control unit 12.

In step S103, the agent control unit 12 acquires agent information corresponding to the input agent ID from the agent information storage unit 121.

The agent information acquired in step S103 in FIG. 6 is hereinafter referred to as “execution agent information.”

In step S104, the agent control unit 12 inputs the execution agent information to the setting unit 13.

In step S105, the setting unit 13 sets a data source ID of the input execution agent information in the search unit 15. In step S106, the setting unit 13 sets a control rule and a system prompt of the execution agent information in the AI control unit 16. As a result, the search unit 15 searches the data storage unit 122 corresponding to the execution agent, and the AI control unit 16 performs the control procedure corresponding to the execution agent.

In step S107, the agent control unit 12 provides the execution agent information to the display control unit 17. In step S108, the display control unit 17 causes an interactive screen in which the conversation partner with the user is an agent (execution agent) related to the execution agent information to be displayed on the terminal apparatus 20.

Specifically, the display control unit 17 generates display data for an interactive screen, and transmits the display data to the terminal apparatus 20 to display the interactive screen.

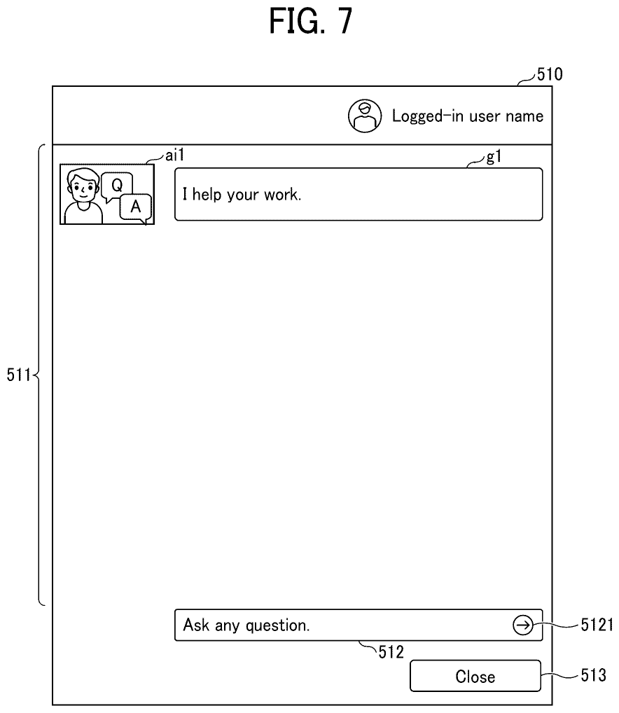

FIG. 7 is a view illustrating an example of display of an interactive screen 510 at the start of conversation. The interactive screen 510 illustrated in FIG. 7 includes an interactive display area 511, a message input area 512, and a button 513. The interactive display area 511 is an area in which the content of the conversation between the execution agent and the user is displayed. In the initial state, the interactive display area 511 displays an introductory sentence g1 (“I help your work.”) prompting the user to input a message. An icon ai1 of the execution agent is displayed on the left of the introductory sentence g1. The icon ai1 is an image stored in a file related to the icon name of the execution agent information. The icon ai1 allows the user to visually recognize the agent (i.e., the execution agent) of the current conversation partner. The message input area 512 is an area for receiving an input of a message from the user, and includes a send icon 5121. The button 513 is a button for receiving an instruction to end the conversation.

When the user inputs a message in the message input area and clicks the send icon 5121, in step S201, the terminal apparatus 20 transmits the message (hereinafter referred to as a “target message”) to the information processing apparatus 10.

When receiving the target message, in step S202, the receiving unit 11 inputs the target message to the agent control unit 12. In step S203, the agent control unit 12 inputs, to the AI control unit 16, an agent selection request including the target message and a list of all items of agent information stored in the agent information storage unit 121. The selection request refers to a request for selecting an agent (hereinafter referred to as a “qualified agent”) qualified to generate a response to the target message. Being qualified to generate a response refers to outputting the most appropriate response.

In step S204, the AI control unit 16 generates a prompt to instruct the AI 150 to select a qualified agent, based on the input target message, the input list of the items of agent information, and a system prompt prepared in advance for selecting a qualified agent, and transmits the prompt to the AI 150. The prompt generated at this time is a prompt requesting selection of an agent having a role that can generate an appropriate response to the message from the user from among multiple agents having different roles. In other words, the prompt is a prompt for causing the AI to determine the type of response desired by the user based on the message input by the user, and for causing the AI to determine the agent that can make the response of the type, based on the role of each agent.

A simple example of the system prompt is as follows.

<Example of system prompt begins.>

Message from user is as follows.

{Message} Candidates for agent that responds to message described above are as follows.

{List of agent IDs and agent descriptive sentences} Select, from among agents described above, agent that can output most appropriate response to message described above, and output agent ID of that agent.

<Example of system prompt ends.>

In this case, the AI control unit 16 applies the target message to the {message} portion of the system prompt, and applies, for each agent, the agent ID and the descriptive sentence of the agent (i.e., the role of the agent) to the {list of agent IDs and agent descriptive sentences} portion of the system prompt to generate a prompt.

The AI 150 which has received the input of the prompt generated as described above selects a qualified agent from among the agents listed in the prompt based on the trained parameters, and generates a response including the ID of the selected agent. The AI 150 transmits the response to the AI control unit 16.

In step S205, the AI control unit 16 receives the response from the AI 150. The response is the agent ID of the agent selected as the qualified agent. In step S206, the AI control unit 16 outputs the agent ID (hereinafter referred to as a “qualified agent ID”) to the agent control unit 12.

In step S207, the agent control unit 12 compares the qualified agent ID output from the AI control unit 16 with the agent ID (hereinafter referred to as an “execution agent ID”) of the execution agent information acquired in step S103 to determine whether an agent that can output a response more appropriate than that of the execution agent to the target message is present.

When the qualified agent ID and the execution agent ID differ from each other, the agent control unit 12 determines that an agent that can output a response more appropriate than that of the execution agent to the target message is present. In this case, steps S210 to S260 are performed, and the execution agent is changed. When the qualified agent ID and the execution agent ID are the same, the agent control unit 12 determines that an agent that can output a response more appropriate than that of the execution agent to the target message is not present. In this case, steps S210 to S260 are not performed, and step S271 and the subsequent steps are performed.

First, a description will be given of the case where the qualified agent ID and the execution agent ID are the same.

In step S271, the agent control unit 12 inputs the target message to the conversion unit 14.

In step S272, the conversion unit 14 converts the input target message into a semantic vector to generate a message vector. In step S273, the conversion unit 14 inputs the message vector (hereinafter referred to as a “target message vector”) and the target message to the search unit 15.

In step S274, the search unit 15 compares the input target message vector with the chunk vector stored for each document data and for each chunk in the data storage unit 122 related to the data source ID set by the setting unit 13 (i.e., the data storage unit 122 corresponding to the execution agent) to identify a similar chunk for each document data and extract some similar chunks having relatively high similarity to the target message. For example, similar chunks having the top X degrees of similarity between the target message vector and the chunk vectors are extracted. The search unit 15 generates, for each of the extracted similar chunks, a search result including related document information of the similar chunk. In step S275, the search unit 15 inputs the search result and the target message to the AI control unit 16.

In step S276, the AI control unit 16 generates a prompt based on the input search result and target message, and the control rule and system prompt set by the setting unit 13. In step S277, the AI control unit 16 transmits the prompt to the AI 150.

In step S278, the AI control unit 16 receives, from the AI 150, a response generated by the AI 150 which has received the input of the prompt. Depending on the control procedure, the first response is not the final response, and the final response is obtained by repeating steps S276 to S278 multiple times.

When obtaining the final response, the AI control unit 16 records the final response in the history information storage unit 123 in association with the target message and the search result.

In step S279, the AI control unit 16 inputs final response information including the final response (hereinafter referred to as a “target final response”) and the related document information included in the search result to the display control unit 17.

In step S280, the display control unit 17 causes the input final response information (the target final response and the related document information) to be displayed on the interactive screen 510 displayed on the terminal apparatus 20. Specifically, the display control unit 17 generates display data of the final response information and transmits the generated display data to the terminal apparatus 20 to cause the final response information to be displayed on the interactive screen 510 displayed on the terminal apparatus 20.

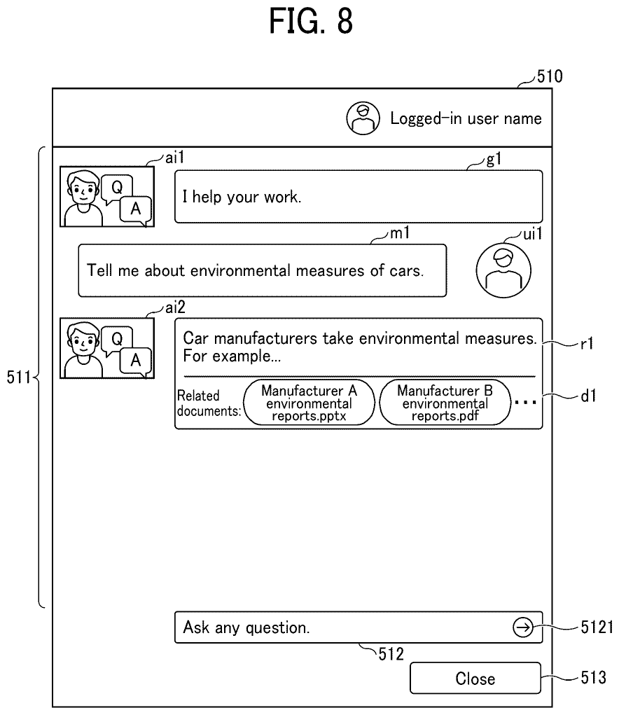

FIG. 8 is a view illustrating an example of display of final response information. In FIG. 8, the same portions as those in FIG. 7 are denoted by the same reference numerals, and descriptions thereof will be omitted. In the interactive screen 510 illustrated in FIG. 8, a message m1, a response r1, and related document information d1 are added.

The message m1 is a target message input by the user in the message input area 512 in step S201. When the user clicks the send icon 5121, the target message input in the message input area 512 is displayed in the interactive display area 511.

The response r1 is a target final response. The related document information d1 is related document information for the target final response. Thus, information including the response r1 and the related document information d1 is final response information for the message m1. FIG. 8 illustrates an example in which a list of document names included in the related document information is displayed as the related document information d1. The target final response may be divided in multiple balloons and output.

In FIG. 8, an icon ui1 is added to the right of the message m1, and an icon ai2 is added to the left of the response r1. The icon ui1 is an icon of the user. The icon ai2 is an icon of the execution agent that has provided the final response. Since the execution agent is not switched, the icon ai2 is the same as the icon ai1.

The user may continue the conversation or may end the conversation. To end the conversation, the user clicks the button 513. In this case, the session ends, and the procedure presented in FIG. 6 ends. To continue the conversation, the user enters a new message in the message input area 512 and clicks the send icon 5121. In this case, step S201 and the subsequent steps are repeated using the message as the target message. That is, step S201 and the subsequent steps are repeatedly performed until the button 513 is clicked.

A description will be given of the case where the qualified agent ID and the execution agent ID differ from each other in the process of performing step S201 and the subsequent steps. This is the case of the determination that an agent that can output a response more appropriate than that from the execution agent to the target message is present. In this case, steps S210 to S260 are performed.

In step S210, the agent control unit 12 acquires agent information corresponding to the qualified agent ID from the agent information storage unit 121 (FIG. 4) as execution agent information. In steps S220 to S250, processing similar to that in steps S104 to S107 is performed. When the new execution agent information is provided in step S250, in step S260, the display control unit 17 causes information that makes the switching of the execution agent identifiable to be displayed on the currently displayed interactive screen 510. Specifically, the display control unit 17 generates display data for displaying information that makes the switching of the execution agent identifiable, and transmits the display data to the terminal apparatus 20.

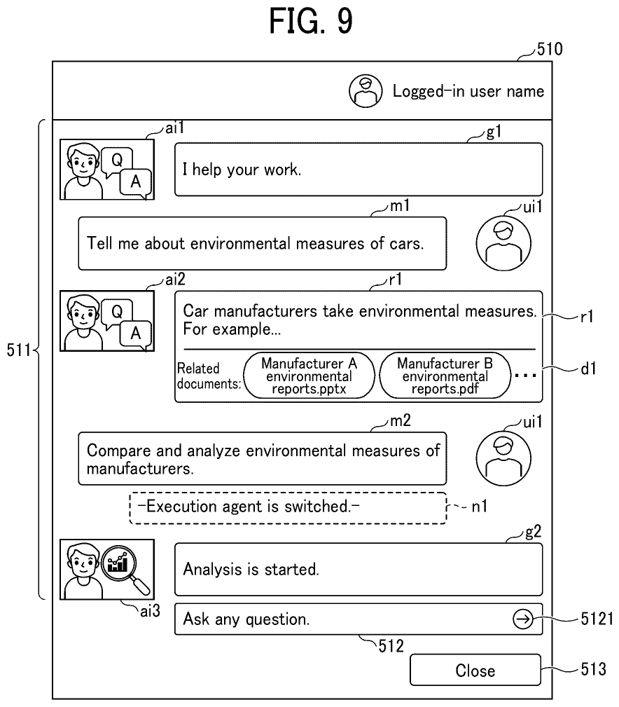

FIG. 9 is a view illustrating an example of display of an interactive screen 510 presenting switching of an execution agent. In FIG. 9, the same portions as those in FIG. 8 are denoted by the same reference numerals, and descriptions thereof will be omitted. In the interactive screen 510 illustrated in FIG. 9, a message m2, a notification sentence n1, and an introductory sentence g2 are added. The message m2 is a new target message. That is, FIG. 9 illustrates an example of display when the qualified agent for the message m2 is not the execution agent.

The notification sentence n1 and the introductory sentence g2 are display information added in step S260 to notify the user of the switching of the execution agent. The notification sentence n1 is a character string indicating the switching of the execution agent. The introductory sentence g2 is an introductory sentence from the new execution agent.

An icon ai3 located on the left of the introductory sentence g2 differs from the icons ai1 and ai2 of the existing execution agents. This is because the icon ai3 is an icon related to the icon name included in the agent information of the new execution agent. As described above, the switching of the icon also enables the user to identify the switching of the execution agent.

After step S260 in FIG. 6, step S271 and the subsequent steps are performed. In step S274, the search unit 15 searches for document data from the data storage unit 122 corresponding to the data source ID set in step S230. The AI control unit 16 performs steps S276 to S278 based on the control rule and the system prompt set in step S240 to obtain a final response. As a result, a response that is based on document data different from that of the execution agent before the switching and that is based on a system prompt (inquiry method) different from that of the execution agent before the switching can be obtained as a final response. That is, a final response corresponding to the execution agent after the switching is obtained. Thus, the possibility of outputting a more appropriate response to a message from the user increases.

As described above, according to the first embodiment, it is determined whether an agent (second agent) is present among multiple types of agents having different roles. The agent (second agent) can output a response more appropriate than that of the execution agent (first agent) to the message from the user for the message to the execution agent (first agent). When such an agent is present, the execution agent is switched to the second agent. Thus, it is possible to provide multiple types of agents (interactive AIs) that can generate multiple types of outputs without additional learning and to switch to the agent that can output a more appropriate response to the message from the user. As a result, the quality of the response to the message from the user can be improved.

Next, a second embodiment of the present disclosure will be described. In the second embodiment, differences from the first embodiment will be described. Thus, the second embodiment is similar to the first embodiment unless otherwise specified.

In the first embodiment, when the execution agent is not the qualified agent, the execution agent is forcibly switched. In the second embodiment, an example will be described in which the user is caused to select whether to switch the execution agent.

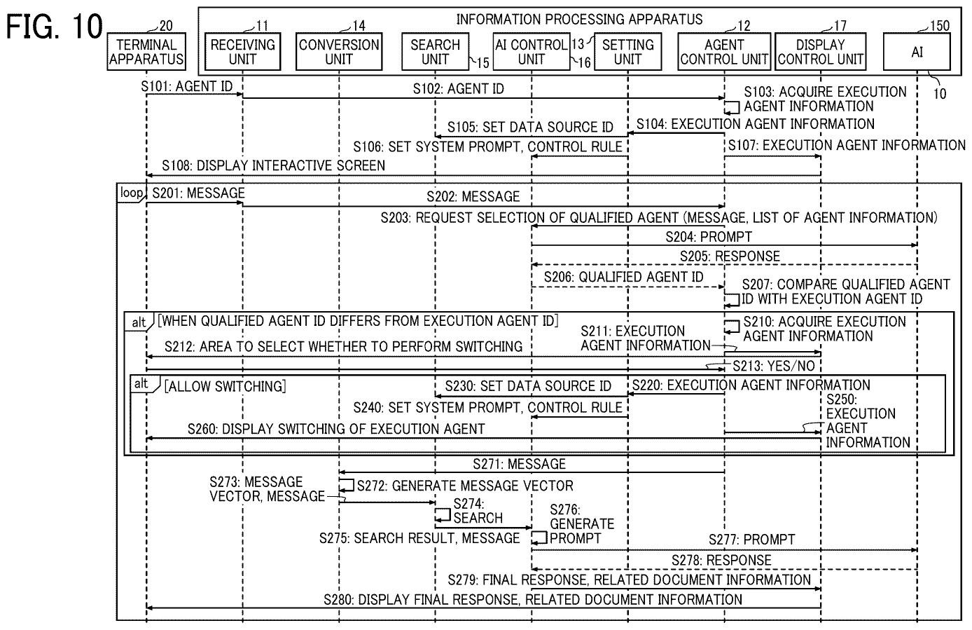

FIG. 10 is a sequence diagram illustrating an example of an operation performed by an information processing system according to the second embodiment. In FIG. 10, the same steps as those in FIG. 6 are denoted by the same step numerals, and descriptions thereof will be omitted. In FIG. 10, steps S211 to S213 are added between steps S210 and S220.

In step S211, the agent control unit 12 provides the execution agent information acquired in step S210 to the display control unit 17.

The display control unit 17 adds a display area (hereinafter referred to as a “selection area”) for causing the user to select whether to switch the execution agent to the currently displayed interactive screen 510, based on the provided execution agent information (the execution agent information of the agent after the switching) to cause a screen for causing the user to select whether to switch the execution agent to be displayed on the terminal apparatus 20.

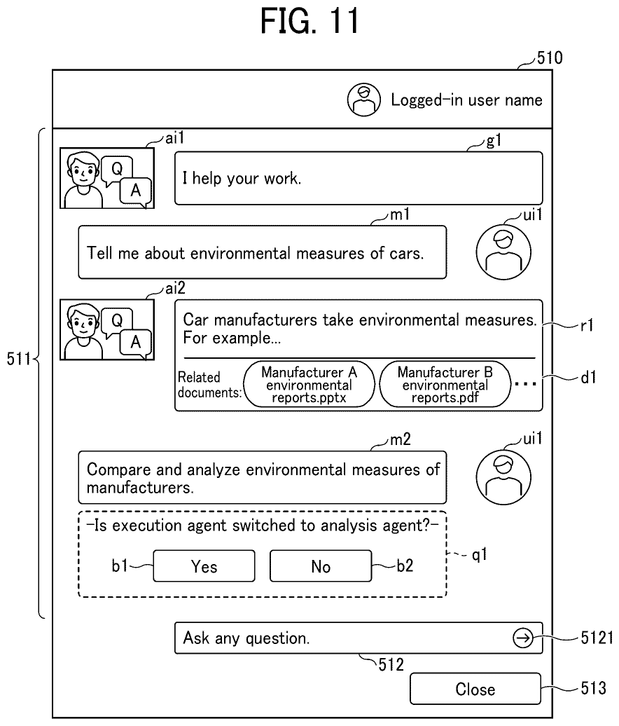

FIG. 11 is a view illustrating an example of display of an interactive screen 510 that causes the user to select whether to switch the execution agent. In FIG. 11, the same portions as those in FIG. 9 are denoted by the same reference numerals, and descriptions thereof will be omitted.

In FIG. 11, a selection area q1 is displayed for the message m2. The selection area q1 is an area for causing the user to select whether to switch the execution agent, and includes a character string indicating whether to switch to the analysis agent, a button b1, and a button b2 in FIG. 11. The button b1 is a button for receiving selection of switching. The button b2 is a button for receiving selection of non-switching.

When the user clicks the button b1 or the button b2, the terminal apparatus 20 transmits information corresponding to the clicked button to the information processing apparatus 10 (S213 in FIG. 10). Specifically, when the button b1 is clicked, the terminal apparatus 20 transmits information indicating “YES,” and when the button b2 is clicked, the terminal apparatus 20 transmits information indicating “NO.”

When receiving the information, the agent control unit 12 branches the process based on the information. When the information indicates “YES,” the agent control unit 12 performs step S220. In this case, in step S260, the display control unit 17 causes information (such as the notification sentence n1, the introductory sentence g2, and the icon ai3 illustrated in FIG. 9) that makes the switching of the execution agent identifiable to be displayed on the interactive screen 510 illustrated in FIG. 11. The information may be displayed below the selection area q1 or may be displayed after the selection area q1 is hidden. Then, a response is made by execution after the switching. In contrast, when the information indicates “NO,” the agent control unit 12 performs step S271. In this case, the execution agent is not switched and a response to the message is made.

As described above, according to the second embodiment, when an agent (second agent) that can output a response more appropriate than that of the execution agent (first agent) to the message from the user to the execution agent is present, the screen (FIG. 11) for causing the user to select whether to switch the execution agent is displayed. Thus, the user's intention can be reflected in the switching of the execution agent.

While the notification sentence n1, the introductory sentence g2, the icon ai3, and the like illustrated in FIG. 9 are presented as examples of information that makes the switching of the execution agent identifiable in step S260 (FIGS. 6 and 10) in the embodiments described above, the information may be implemented in any other form. For example, in step S260, the display control unit 17 may display the agent name of the execution agent in addition to the icon ai3 or instead of the icon ai3.

Alternatively, in step S260, the display control unit 17 may cause a new interactive screen 510 for interacting with the execution agent after the switching to be displayed on the terminal apparatus 20, independently of the currently displayed interactive screen 510. The display may be performed in any other form as long as the user can identify the switching of the execution agent.

While the example in which the qualified agent is identified by the procedure presented in steps S202 to S206 (FIGS. 6 and 10) has been described in the embodiments, the qualified agent may be identified by another procedure.

For example, after the qualified agent is identified, when the qualified agent differs from the current execution agent in step S207, whether to switch the current execution agent may be determined. In this case, following step S207, the agent control unit 12 inputs the target message and the agent information of the current execution agent (execution agent information) to the AI control unit 16. The AI control unit 16 generates a prompt for inquiring whether to switch the execution agent using the target message and the descriptive sentence of the execution agent information. For example, a prompt having content such as “Is execution agent, which plays role as described in descriptive sentence, qualified for making response to target message?” may also be generated. The AI control unit 16 transmits the prompt to the AI 150 and receives a response from the AI 150. The AI control unit 16 outputs the response to the agent control unit 12. When the response indicates that the execution agent is qualified, the agent control unit 12 performs step S271 without switching the execution agent. When the response indicates that the execution agent is not qualified, the agent control unit 12 performs step S210 to switch the execution agent.

Alternatively, after it is determined whether the execution agent is qualified, when the execution agent is not qualified, the qualified agent may be identified. The procedure for determining whether the execution agent is qualified and the procedure for identifying the qualified agent are as described above.

As described above, the control rule is prepared for each agent in advance, and thus it is possible to switch the conversation partner to another agent that makes an appropriate response to a message input by the user, based on the descriptive sentence describing the role of the agent implemented by the agent being controlled according to the control rule and what the agent can do, and the message input by the user.

A specific example of one or more phases performed by three types of agents having different roles based on a processing flow (a control rule and a system prompt) will be described below. When the processing flow (the control rule and the system prompt) corresponding to the execution agent is set in step S240 in FIG. 6 or FIG. 10, a prompt based on the set processing flow is generated in step S276, and when the prompt is input to the AI 150 based on the processing flow, respective different phases can be performed for the three types of agents as described below. In the following example, a prompt for the AI 150 is transmitted (input) for each phase, and a response from the AI 150 is received each time the prompt for the AI 150 is transmitted (input). When one of the phases is completed, the next phase is performed.

### First Example: Inquiry Agent

The inquiry agent is an agent whose role is to receive a message as a question and generate an answer to the question. The control rule of the inquiry agent includes, for example, one following phase.

Phase 1: The AI 150 is caused to generate an answer using the search result in step S274.

### Second Example: Comparison Agent

The comparison agent is an agent whose role is to compare multiple items of document data. For example, the comparison agent is effective when the sales information details of the previous month are compared with the sales information details of the current month or when the parts purchasing department compares the detailed information of a selected part A with the detailed information of a selected part B. The comparison target is designated in a message. For example, in the example described above, messages such as a message “Compare sales information details of previous month with sales information details of current month.”, and a message “Compare detailed information of selected part A with detailed information of selected part B.” are expected to be input. Thus, in the case of the comparison agent, (chunks related to) two items of document data to be compared are included in the search result. The control rule of the comparison agent includes, for example, the following four phases in order. Hereinafter, each chunk group of the document data to be compared will be referred to as “target data.”

Phase 1: The AI 150 is caused to extract topics from respective items of target data searched for as comparison targets. The topic is, for example, a point of view for comparison. The topic may be designated in a message. In this case, the designated topic is extracted from the message. To which of the two items of target data to be compared each chunk included in the search result belongs can be identified based on the document data including the chunk.

Phase 2: A topic to be used as a comparison item is determined from among the topics extracted on target data basis. The topic is determined by inputting, to the AI 150, a prompt to instruct determination of the topic to be used as the comparison item from among one or more topics extracted in phase 1. Alternatively, all the topics extracted in phase 1 may be used as comparison items, or topics extracted from both of the items of target data (i.e., the AND of the extraction results of topics on target data basis) may be used as comparison items.

Phase 3: Loop processing is performed for each comparison item. In one-time loop processing, (1) a process of extracting data (hereinafter referred to as “comparison data”) related to a comparison item to be processed (hereinafter referred to as a “target comparison item”) from each target data, (2) a process of comparing the comparison data extracted from each target data, and (3) a process of summarizing comparison results are performed in the order of (1) to (3). (1) The process of extracting the target comparison item from each target data is a process of causing the AI 150 to extract, for each target data, comparison data (document information) corresponding to the topic related to the target comparison item. The process can be performed by inputting, to the AI 150, a prompt to instruct extraction of a portion corresponding to the target comparison item from each target data. An example of the prompt is as follows.

“Extract sales information at each sales area in November and December 2024.”

“Extract customer information at each sales area in November and December 2024.”

(2) The process of comparing the comparison data extracted from each target data is a process of comparing the comparison data of each target data and generating a comparison result. For example, when the comparison data is data related to sales of a store, the sales, the number of customers, the customer unit price, the cost rate, the labor cost, the campaign content, the sales promotion cost, and the like are compared. The comparison content depends on the system prompt corresponding to phase 3. The process can be performed by inputting, to the AI 150, a prompt to compare the comparison data of each target data and instruct generation of the comparison result.

An example of the prompt is as follows.

“Compare sales information at each sales area in November and December 2024.”

“Compare customer information at each sales area in November and December 2024.”

(3) The process of summarizing the comparison results is a process of generating a consideration based on the comparison results. With the comparison results related to the sales of the store, for example, the location of a good sales area, the location of a bad sales area, a countermeasure against the bad sales, and a prediction of the effect of the event to be held in the next month are generated. The content of the consideration depends on the system prompt. The process can be performed by inputting, to the AI 150, a prompt to instruct generation of the consideration based on the comparison results. An example of the prompt is as follows.

“Summarize comparison results of sales information at each sales area in November and December 2024. Use scheduled campaign information etc. to add prediction for January 2025. In case of bad sales, add solution.”

“Summarize comparison results of customer information at each sales area in November and December 2024. Use scheduled campaign information etc. to add prediction for January 2025. In case of bad sales, add solution.”

Phase 4: A summary of the entirety of the comparison results of the comparison items is generated. This is a process of summarizing the comparison results generated for each topic and generating a document related to all the comparison results. The process can be performed by, for example, inputting the following prompt to the AI 150.

“Summarize comparison results of various types of comparison information at each sales area in November and December 2024. Use scheduled campaign information etc. to add prediction for January 2025. In case of bad sales, add solution.

{Comparison results}”

The comparison results for each comparison item are applied to {comparison results}.

### Third Example: Document Generation Agent

The document generation agent is an agent having a role of generating a document according to a specific configuration. For example, a message “Prepare application form according to format of XXX application form” is expected to be input to the document generation agent. In this case, document data (chunk) related to the “XXX application form” is included in the search result. The control rule of the document generation agent includes, for example, the following three phases in order.

Phase 1: A document configuration to be generated is determined. In phase 1, first, a prompt to instruct selection of a processing flow (a control rule and a system prompt) suitable for generating a document according to the message is input to the AI 150. Then, a prompt (an example of a first instruction to generate a document configuration) according to the processing flow selected by the AI 150 is input to the AI 150 to cause the AI 150 to generate the corresponding document configuration.

Phase 2: Loop processing is performed for each item serving as a minimum unit (hereinafter referred to as a “minimum item”) in the document configuration generated in phase 1. The minimum item of the document configuration refers to an item corresponding to the lowest level in the hierarchical structure of the document configuration. For example, in a document configuration having a three-level hierarchical structure including one or more large items (e.g., chapters), each large item including one or more medium items (e.g., sections), each medium item including one or more small items (e.g., clauses), the small item corresponds to the minimum item. In a document configuration without the hierarchical structure (i.e., a document configuration in which items are in a parallel relationship), each item is the minimum item. The minimum items are to be processed in order of appearance in the document configuration (e.g., in the order from the top of the table of contents). Hereinafter, the minimum item to be processed in the loop processing is referred to as a “target item.” In one-time loop processing, (1) a process of extracting information used to generate the target item from the search result and (2) a process of generating the document content of the target item using the extracted information are performed in the order of (1) and (2).

(1) The process of extracting the information used to generate the target item from the search result can be performed by inputting, to the AI 150, a prompt to instruct extraction of information related to the target item from the search result.

(2) The process of generating the document content of the target item using the extracted information can be performed by inputting, to the AI 150, a prompt to instruct generation of the document of the target item using the extracted information (an example of a second instruction to cause the AI 150 to generate the document content based on the document configuration generated based on the first instruction).

Phase 3: Adjustment is performed such that the entire configuration is completed. This is a process of completing the entire document content generated for each item and summarizing the document content in one document. For example, phase 3 can be performed by inputting, to the AI 150, the following prompt (an example of a third instruction for completing the entirety of the document content generated based on the second instruction).

“Complete following documents to be established as one statement without changing content or amount of documents. {Document for each minimum item}”

Each document generated in phase 2 is applied to {document for each minimum item}.

While the three agents are exemplified above, as is apparent from the above description, the system prompt is prepared for each phase, and each phase is implemented by inputting, to the AI 150, the prompt based on the system prompt corresponding to the phase. The control rule and the system prompt for each agent are created and set by, for example, an administrator. The administrator may differ depending on the agent.

Since the processing flows of the agents differ from each other, the agents can be selectively used based on the purpose. Even when the agents refer to the same data source, the agents provide respective different outputs.

The detailed processing flow including one or more phases can provide multiple agents that can output respective different outputs without performing machine learning in advance.

A specialized agent can be implemented for each output.

The generation AI repeats transmitting a prompt and receiving a response for one question from the user many times in the background to provide a more advanced output.

The information processing apparatus 10 is not limited to a general-purpose computer and may be any apparatus or device having a communication function. Other examples of the information processing apparatus 10 include, but not limited to, an output device such as a projector (PJ), an interactive white board (IWB, a white board having an electronic whiteboard function enabling interactive communication), or a digital signage, a head up display (HUD) device, an industrial machine, an imaging device, a sound collecting device, a medical device, a network home appliance, a notebook personal computer (PC), a mobile phone, a smartphone, a tablet terminal, a game console, a personal digital assistant (PDA), a digital camera, a wearable PC, or a desktop PC.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The apparatuses or devices described in the embodiments are merely one example of plural computing environments that implement one or more embodiments disclosed herein.

In some embodiments, the information processing apparatus 10 includes multiple computing devices, such as a server cluster. The multiple computing devices communicate with one another through any type of communication link including a network, a shared memory, or the like and perform the processes disclosed herein. The terminal apparatus 20 may also include multiple computing devices configured to communicate with one another.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The following non-limiting examples illustrate aspects of the present disclosure.

<1>

According to Aspect 1, an information processing system that provides a first interactive AI and a second interactive AI that interact with a user using response content generated by an AI includes a storage unit that stores a first processing flow in association with the first interactive AI, the first processing flow generating response content to be responded by the first interactive AI to a message of the user, and a second processing flow in association with the second interactive AI, the second processing flow generating response content to be responded by the second interactive AI to the message; a receiving unit that receives an input of a message from the user; an AI control unit that transmits an instruction based on the first processing flow to the AI when receiving a message to the first interactive AI, and transmits an instruction based on the second processing flow to the AI when receiving a message to the second interactive AI; and a display control unit that causes response content obtained from the AI based on the first processing flow or the second processing flow to be displayed.

<2>

According to Aspect 2, in the information processing system of Aspect 1, the first processing flow includes a process of transmitting an instruction to generate response content to the AI to output response content as the first interactive AI to the message.

<3>

According to Aspect 3, in the information processing system of Aspect 1 or Aspect 2, the first processing flow includes multiple instructions to be sequentially transmitted to the AI, and the multiple instructions include a first instruction and a second instruction to be transmitted to the AI when a first response is obtained from the AI in response to the first instruction.

<4>

According to Aspect 4, in the information processing system of Aspect 3, the second instruction instructs the AI to respond using the first response from the AI in response to the first instruction.

<5>

According to Aspect 5, in the information processing system of any one of Aspect 1 to Aspect 4, the first processing flow is a processing flow to control a behavior as the first interactive AI.

<6>

According to Aspect 6, in the information processing system of any one of Aspect 1 to Aspect 5, each of the first processing flow and the second processing flow includes multiple instructions to be sequentially transmitted to the AI, and the first processing flow has a number of the multiple instructions different from a number of the multiple instructions of the second processing flow.

<7>

According to Aspect 7, in the information processing system of any one of Aspect 1 to Aspect 6, the first interactive AI has a role different from a role of the second interactive AI.

<8>

According to Aspect 8, in the information processing system of any one of Aspect 1 to Aspect 7, the first interactive AI is an interactive AI having a role of generating a document, and the first processing flow includes a process of transmitting instructions to the AI, the instructions including a first instruction to cause the AI to generate a document configuration based on a message from the user; a second instruction to cause the AI to generate document content based on the document configuration generated based on the first instruction; and a third instruction to complete an entirety of the document content generated in response to the second instruction.

<9>

According to Aspect 9, an information processing apparatus that provides a first interactive AI and a second interactive AI that interact with a user using response content generated by an AI includes a storage unit that stores a first processing flow in association with the first interactive AI, the first processing flow generating response content to be responded by the first interactive AI to a message of the user, and a second processing flow in association with the second interactive AI, the second processing flow generating response content to be responded by the second interactive AI to the message; a receiving unit that receives an input of a message from the user; an AI control unit that transmits an instruction based on the first processing flow to the AI when receiving a message to the first interactive AI, and transmits an instruction based on the second processing flow to the AI when receiving a message to the second interactive AI; and a display control unit that transmits display data to cause response content obtained from the AI based on the first processing flow or the second processing flow to be displayed.

<10>

According to Aspect 10, an information processing method executed by an information processing apparatus that provides a first interactive AI and a second interactive AI that interact with a user using response content generated by an AI includes a receiving procedure of receiving an input of a message from the user; an AI control procedure of transmitting an instruction based on a first processing flow to the AI when receiving a message to the first interactive AI, the first processing flow being stored in a storage unit in association with the first interactive AI and generating response content to be responded by the first interactive AI to the message of the user; and transmitting an instruction based on a second processing flow to the AI when receiving a message to the second interactive AI, the second processing flow being stored in the storage unit in association with the second interactive AI and generating response content to be responded by the second interactive AI to the message of the user; and a display control procedure of causing response content obtained from the AI based on the first processing flow or the second processing flow to be displayed.

<11>

According to Aspect 11, a program causes an information processing apparatus that provides a first interactive AI and a second interactive AI that interact with a user using response content generated by an AI to execute a receiving procedure of receiving an input of a message from the user; an AI control procedure of transmitting an instruction based on a first processing flow to the AI when receiving a message to the first interactive AI, the first processing flow being stored in a storage unit in association with the first interactive AI and generating response content to be responded by the first interactive AI to the message of the user; and transmitting an instruction based on a second processing flow to the AI when receiving a message to the second interactive AI, the second processing flow being stored in the storage unit in association with the second interactive AI and generating response content to be responded by the second interactive AI to the message of the user; and a display control procedure of causing response content obtained from the AI based on the first processing flow or the second processing flow to be displayed.

1. An information processing system comprising:
circuitry configured to activate at least one of a first interactive artificial intelligence (AI) and a second interactive AI that each interact with a user using response content generated by an AI;
a memory that stores a first processing flow and the first interactive AI in association, and a second processing flow and the second interactive AI in association; and
a display to display the response content,
wherein the circuitry is configured to:
receive a message input from the user;
based on a determination that the first interactive AI is to process the message,
transmit an instruction based on the first processing flow to the AI, the first processing flow causing the first interactive AI to generate response content to be responded to the message of the user, and
display the response content obtained from the AI based on the first processing flow on a display; and
based on a determination that the second interactive AI is to process the message,
transmit an instruction based on the second processing flow to the AI, the second processing flow causing the second interactive AI to generate response content to be responded to the message of the user, and
display the response content obtained from the AI based on the second processing flow on the display.

2. The information processing system according to claim 1, wherein the first processing flow includes
a process of transmitting an instruction to generate response content to the AI, the response content is to be output from the first interactive AI in response to the message of the user.

3. The information processing system according to claim 1,
wherein the first processing flow includes multiple instructions to be sequentially transmitted to the AI, and
the multiple instructions including a first instruction, and a second instruction to be transmitted to the AI when a first response is obtained from the AI in response to the first instruction.

4. The information processing system according to claim 3, wherein the second instruction instructs the AI to respond using the first response, the first response being received from the AI in response to the first instruction.

5. The information processing system according to claim 1, wherein the first processing flow controls a behavior as the first interactive AI.

6. The information processing system according to claim 1,
wherein each of the first processing flow and the second processing flow includes multiple instructions to be sequentially transmitted to the AI, and
wherein the first processing flow has a number of the multiple instructions different from a number of the multiple instructions of the second processing flow.

7. The information processing system according to claim 1, wherein the first interactive AI has a role different from a role of the second interactive AI.

8. The information processing system according to claim 1,
wherein the first interactive AI is an interactive AI having a role of generating a document, and
wherein the first processing flow includes a process of transmitting instructions to the AI, the instructions including:
a first instruction to cause the AI to generate a document configuration based on a message from the user;
a second instruction to cause the AI to generate document content based on the document configuration generated based on the first instruction; and
a third instruction to complete an entirety of the document content generated in response to the second instruction.

9. The information processing system according to claim 8, comprising:
an information processing apparatus including the circuitry and the memory; and
a terminal apparatus communicably connected with the information processing apparatus via a network and including the display.

10. An information processing apparatus comprising:
circuitry configured to activate at least one of a first interactive artificial intelligence (AI) and a second interactive AI that each interact with a user using response content generated by an AI; and
a memory that stores a first processing flow and the first interactive AI in association, and a second processing flow and the second interactive AI in association,
wherein the circuitry is configured to:
receive a message input from the user;
based on a determination that the first interactive AI is to process the message,
transmit an instruction based on the first processing flow to the AI, the first processing flow causing the first interactive AI to generate response content to be responded to the message of the user, and
display the response content obtained from the AI based on the first processing flow on a display; and
based on a determination that the second interactive AI is to process the message,
transmit an instruction based on the second processing flow to the AI, the second processing flow causing the second interactive AI to generate response content to be responded to the message of the user, and
display the response content obtained from the AI based on the second processing flow on the display.

11. An information processing method comprising:
receiving a message input from a user; and
determining an interactive artificial intelligence (AI) configured to process the message from among a first interactive AI and a second interactive AI that each interact with the user using response content generated by an AI,
wherein, when the determining determines that the first interactive AI is to process the message, the method further comprising:
transmitting an instruction based on a first processing flow to the AI, the first processing flow being stored in a memory in association with the first interactive AI and causing the first interactive AI to generate response content to be responded to the message of the user; and
displaying the response content obtained from the AI based on the first processing flow on a display, and
wherein, when the determining determines that the second interactive AI is to process the message, the method further comprising:
transmitting an instruction based on a second processing flow to the AI, the second processing flow being stored in the memory in association with the second interactive AI and causing the second interactive AI to generate response content to be responded to the message of the user, and
displaying the response content obtained from the AI based on the second processing flow on the display.
